(19) United States
(12) Patent Application Publication
(10) Pub. No.: US 2006/0090016 A1
(43) Pub. Date: Apr. 27, 2006

(54) Mechanism to pull data into a processor cache

(76) Inventor: Samantha J. Edirisooriya, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/974,377

(22) Filed: Oct. 27, 2004

(51) Int. Cl. G06F 13/28

(52) U.S. Cl. 710/22

(57) ABSTRACT

A computer system is disclosed. The computer system includes a host memory, an external bus coupled to the host memory and a processor coupled to the external bus. The processor includes a first central processing unit (CPU), an internal bus coupled to the CPU and a direct memory access (DMA) controller coupled to the internal bus to retrieve data from the host memory directly into the first CPU.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer systems; more particularly, the present invention relates to cache memory systems.

### BACKGROUND

Many storage, networking, and embedded applications require fast input/output (I/O) throughput for optimal performance. I/O processors allow servers, workstations and storage subsystems to transfer data faster, reduce communication bottlenecks, and improve overall system performance by offloading I/O processing functions from a host central processing unit (CPU). Typically I/O processors process Scatter Gather List (SGLs) generated by the host to initiate necessary data transfers. Usually these SGLs are moved to the I/O processor's local memory from the host memory, before I/O processors start processing the SGLs. Subsequently, the SGLs are processed by being read from local memory.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates one embodiment of an I/O processor; and

FIG. 3 is a flow diagram illustrating one embodiment of using a DMA engine to pull data into a processor cache.

### DETAILED DESCRIPTION

According to one embodiment, a mechanism to pull data into a processor cache is described. In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

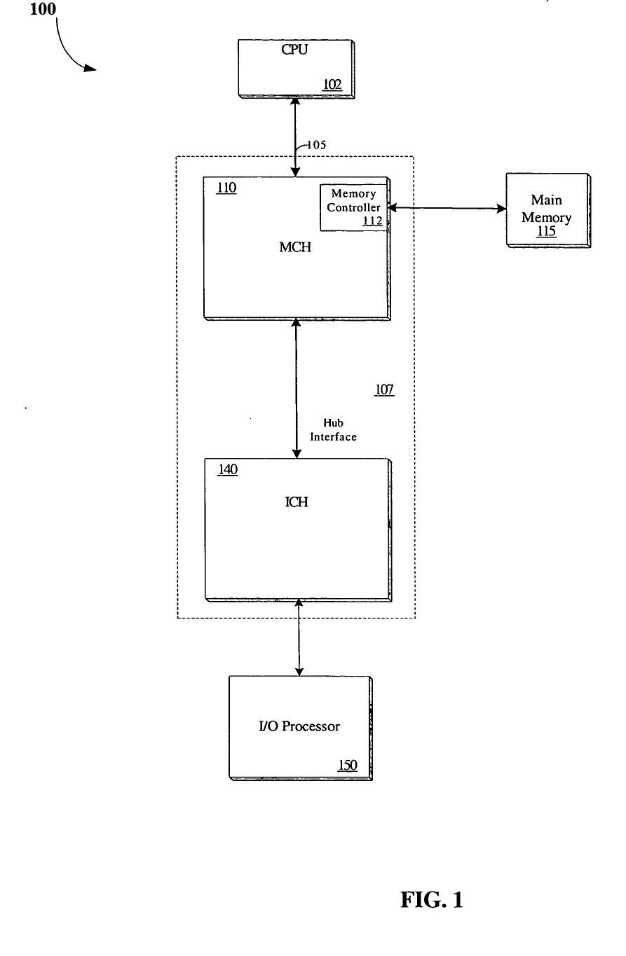

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium( II processor family, Pentium(® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions that are executed by CPU 102 or any other device included in system 100. In one embodiment, main system memory 115 includes dynamic random access memory (DRAM); however, main system memory 115 may be implemented using other memory types. Additional devices may also be coupled to bus 105, such as multiple CPUs and/or multiple system memories.

Chipset 107 also includes an input/output control hub (ICH) 140 coupled to MCH 110 to via a hub interface. ICH 140 provides an interface to input/output (I/O) devices within computer system 100. For instance, ICH 140 may be coupled to a Peripheral Component Interconnect Express (PCI Express) bus adhering to a Specification Revision 2.1 bus developed by the PCI Special Interest Group of Portland, Oreg.

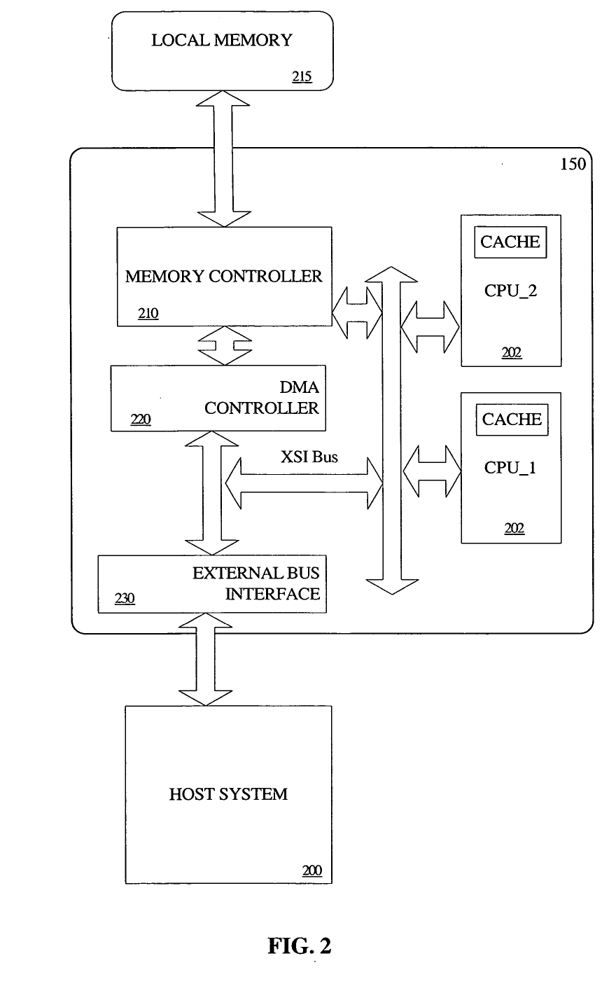

According to one embodiment, ICH 140 is coupled an I/O processor 150 via a PCI Express bus. I/O processor 150 transfers data to and from ICH 140 using SGLs. FIG. 2 illustrates one embodiment of an I/O processor 150. I/O processor 150 is coupled to a local memory device 215 and a host system 200. According to one embodiment, host system 200 represent CPU 102, chipset 107, memory 115 and other components shown for computer system 100 in FIG. 1.

Referring to FIG. 2, I/O processor 150 includes CPUs 202 (e.g., CPU_1 and CPU_2), a memory controller 210, DMA controller 220 and an external bus interface 230 coupled to host system 200 via an external bus. The components of I/O 150 are coupled via an internal bus. According to one embodiment, the bus is an XSI bus.

The XSI is a split address data bus where the data and address are tied with a unique Sequence ID. Further, the XSI bus provides a command called “Write Line” (or “Write” in the case of writes less than a cache line) to perform cache line writes on the bus. Whenever a PUSH attribute is set during a Write Line (or Write), one of the CPUs 202 (CPU_1 or CPU_2) on the bus will claim the transaction if a Destination ID (DID) provided with the transaction matches the ID of the particular CPU 202

Once the targeted CPU 202 accepts the Write Line (or Write) with PUSH, the agent that originated the transaction will provide the data on the data bus. During the address phase the agent generating the command generates a Sequence ID. Then during the data transfer the agent supplying data uses the same sequence ID. During reads the agent claiming the command will supply data, while during writes the agent that generated the command provides data.

In one embodiment, XSI bus functionality is implemented to enable DMA controller 220 to pull data directly in to a cache of a CPU 202. In such an embodiment, DMA controller 220 issues a set of Write Line (and/or Write) with PUSH commands targeting a CPU 202 (e.g., CPU_1). CPU_1 accepts the commands, stores the Sequence IDs and waits for data.

DMA controller 220 then generates a sequence of Read Line (and/or Read) commands with the same sequence IDs used during Write Line (or Write) with PUSH commands. Interface unit 230 claims the Read Line (or Read) commands and generates corresponding commands on the external bus. When data returns from host system 200, interface unit 230 generates corresponding data transfers on the XSI bus. Since they have matching sequence IDs, CPU_1 claims the data transfers and stores them in its local cache.

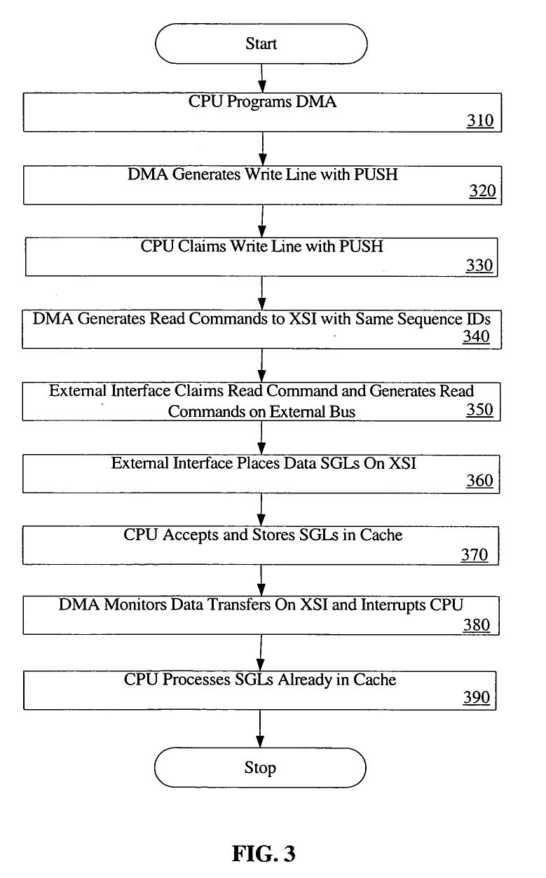

FIG. 3 is a flow diagram illustrating one embodiment of using DMA engine 220 to pull data into a CPU 202 cache. At processing block 310, a CPU 202 (e.g., CPU_1) programs DMA controller 220. At processing block 320, DMA generates a Write Line (or Write) with PUSH command. At processing block 330, CPU_1 claims the Write Line (or Write) with PUSH.

At processing block 340, DMA controller 220 generates read commands to the XSI Bus with the same Sequence IDs. At processing block 350, external bus interface 230 claims the read command and generates read commands on the external bus. At processing block 360, external bus interface 230 places received data (e.g., SGLs) on the XSI bus. At processing block 370, CPU_1 accepts the data and stores the data in the cache. At processing block 380, DMA controller 220 monitors data transfers on the XSI bus and interrupts CPU_1. At processing block 390, CPU_1 begins processing the SGLs that are already in the cache.

The above-described mechanism takes advantage of a PUSH cache capability of a CPU within an I/O processor to move SGLs directly to the CPU's cache. Thus, there is only one data (SGL) transfer that occurs on the internal bus. As a result, traffic is reduced on the internal bus and latency is improved since it is not required to move SGLs first in to a local memory external to the I/O processor.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer system comprising:
a host memory;
an external bus coupled to the host memory; and
a processor, coupled to the external bus, having:
a first central processing unit (CPU);
an internal bus coupled to the CPU; and
a direct memory access (DMA) controller, coupled to the internal bus, to retrieve data from the host memory directly into the first CPU.

2. The computer system of claim 1 wherein the internal bus is a split address data bus.

3. The computer system of claim 1 wherein the first CPU includes a cache memory, wherein the data retrieved from the host memory is stored in the cache memory.

4. The computer system of claim 3 wherein the processor further comprises a bus interface coupled to the internal bus and the external bus.

5. The computer system of claim 4 wherein the processor further comprises a second CPU coupled to the internal bus.

6. The computer system of claim 5 wherein the processor further comprises a memory controller.

7. The computer system of claim 6 further comprising a local memory coupled to the processor.

8. A method comprising:
a direct memory access (DMA) controller issuing a write command to write data to a central processing unit (CPU) via a split address data bus;
retrieving the data from an external memory device; and
writing the data directly into a cache within the CPU via the split address data bus.

9. The method of claim 8 further comprising the DMA controller generating a sequence ID upon issuing the write command.

10. The method of claim 9 further comprising:
the CPU accepting the write command; and
storing the sequence ID.

11. The method of claim 10 further comprising the DMA controller generating one or more read commands having the sequence ID.

12. The method of claim 11 further comprising:
an interface unit receiving the read command; and
generating a command via an external bus to retrieve the data from the external memory.

13. The method of claim 12 further comprising:
the interface unit transmitting the retrieved data on the split address bus; and
the processor capturing the data from the split address bus.

14. An input/output (I/O) processor comprising:
a first central processing unit (CPU) having a first cache memory;
a spilt address data bus coupled to the CPU; and
a direct memory access (DMA) controller, coupled to the spilt address data bus, to retrieve data from a host memory directly into the first cache memory.

15. The I/O processor of claim 14 wherein the first CPU includes an interface coupled to an external bus to retrieve the data from the host memory.

16. The I/O processor of claim 15 wherein the processor further comprises a second CPU having a second cache memory.

17. The I/O processor of claim 16 wherein the processor further comprises a memory controller.
